(19) United States
(12) Patent Application Publication
(10) Pub. No.: US 2016/0196728 A1
(43) Pub. Date: Jul. 7, 2016

(54) METHOD AND SYSTEM FOR DETECTING A SECURITY BREACH IN AN ORGANIZATION

(71) Applicant: Wipro Limited, Bangalore (IN)

(72) Inventors: Abhishek Suman, Nalanda (IN); Sreevidya Khatravath, Ranga Reddy (IN); Manikhantan Sankara Raman, Chennai (IN)

(21) Appl. No.: 14/639,378

(22) Filed: Mar. 5, 2015

(30) Foreign Application Priority Data
Jan. 6, 2015 (IN) 103/CHE/2015

(51) Int. Cl. G08B 13/00; G06T 7/20; G06T 7/00; G06K 9/00

(52) U.S. Cl. CPC G08B 13/00; G06K 9/00255; G06T 7/20; G06K 9/00288; G06K 9/00342; G06T 7/0081; G06T 2207/30241; G06T 2207/30201

(57) ABSTRACT

Embodiments of the present disclosure disclose methods, non-transitory computer readable media, and a security breach detection computing devices for detecting a breach of security in an organization. The method comprises receiving input data in real-time from one or more security systems. The method further comprises analyzing the input data to generate at least one of security information in a predefined format, trajectory information on movement of one or more persons, and facial features of the one or more persons. The method further comprises correlating the security information, the trajectory information and the facial features. The method further comprises detecting the security breach in the organization based on the correlation.

This application claims the benefit of Indian Patent Application No. 103/CHE/2015 filed Jan. 6, 2015, which is hereby incorporated by reference in its entirety.

### FIELD

The present subject matter is related, in general to access control systems and more particularly, but not exclusively to a method and a system for detecting a security breach in an organization.

### BACKGROUND

Large organization or corporations, wherein tens of thousands of employees work, it is not easy to have a system which can accurately track employees, detect people entering to restricted areas in offices etc. Many companies restrict access to only authorized personnel inside a secured zone to avoid confidentiality breach by using Access Control Systems (ACS), such as Radio Frequency Identification (RFID) access systems. Also, biometric authentication systems are used for recording people's identity, enforcing that only right person gets access to specific places. The ACS require that an individual type in a Personal Identification Number (PIN) on a pad, or use a badge, proximity card, swipe a card or one fingerprint on a reader, and the like for validating the person.

These ACS are not fool proof as they allow access to more than one person through a secure door or gate once the credentials of one authorized person have been validated. Typical ACS are not able to recognize the existence of other persons in the vicinity. Hence, it is easy for people to get inside a restricted area by simply tailgating others. Such, security breaches can cost a lot of money and credibility to the company, and they are usually not identified until it is too late.

There are various systems used today for enforcing added security layer on existing stack like retina reader, turnstiles, PIN authentications systems etc. But, using these systems for enhancing security increases the time and complexity involved during authentication. This issue becomes even more complicated and time consuming when there are tens of thousands of persons to be monitored every day. The existing security measures are not competent enough so the employees may misuse these systems for their advantage.

The issues mainly faced while determining the security breach incidents at real-time are to avoid tailgating, piggybacking, prevent unauthorized access to restricted areas, reduce the complexity and time taken with the existing tracking systems, identify security breach incidents at real-time.

### SUMMARY

Disclosed herein is a method and system for detecting a security breach in an organization. The method comprises receiving and analyzing the real-time security surveillance information from different security systems. Then, the security breach incidents are detected based on available data sources and configured breach category. Consequently, real-time alert notifications are raised and a detailed view of all security breach incidents is provided.

In an aspect of the present disclosure, a method for detecting a security breach in an organization is provided. The method comprises receiving input data in real-time from one or more security systems. Then, the method comprises analyzing the input data to generate at least one of security information in a predefined format, trajectory information on movement of one or more persons, and facial features of the one or more persons. Further, the method comprises correlating the security information, the trajectory information and the facial features and detecting the security breach in the organization based on the correlation

In an embodiment of the present disclosure, a security breach detection computing device or system for detecting a security breach in an organization is provided. The security breach detection system comprises a processor and a memory communicatively coupled to the processor. The memory stores processor-executable instructions, which, on execution, causes the processor to receive input data in real-time from one or more security systems, analyze the input data to generate at least one of security information in a predefined format, trajectory information on movement of one or more persons and facial features of the one or more persons, correlate the security information, the trajectory information and the facial features, and detect the security breach in the organization based on the correlation.

In another aspect of the present disclosure, a non-transitory computer readable medium is disclosed. The non-transitory computer readable medium includes instructions stored thereon that when processed by a processor causes a system to perform operations comprising receiving input data in real-time from one or more security systems. The operations further comprise analyzing the input data to generate at least one of security information in a predefined format, trajectory information on movement of one or more persons and facial features of the one or more persons. The operations further comprise correlating the security information, the trajectory information and the facial features and detecting the security breach in the organization based on the correlation.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates a block diagram of an exemplary security breach detection system for detecting a security breach in an organization in accordance with some embodiments of the present disclosure;

FIG. 2 illustrates an exemplary block diagram of a processing engine in accordance with some embodiments of the present disclosure;

FIG. 3 illustrates an exemplary block diagram of a cognition engine in accordance with some embodiments of the present disclosure;

FIG. 4 shows a flowchart illustrating a method for detecting a security breach in an organization in accordance with some embodiments of the present disclosure; and

FIG. 5 illustrates a block diagram of an exemplary computer system for implementing embodiments consistent with the present disclosure.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

Embodiments of the present disclosure are related to a method and a system for detecting a security breach in an organization. The system receives real-time security surveillance information from different security systems and analyzes the same for the different security breach incidents. Further, the system raises real-time alert notifications and provides a detailed view of all security breach incidents.

The term person refers to an employee of the organization or any other person entering the premises of organization.

The term organization refers to any entity, such as an institution or an association.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

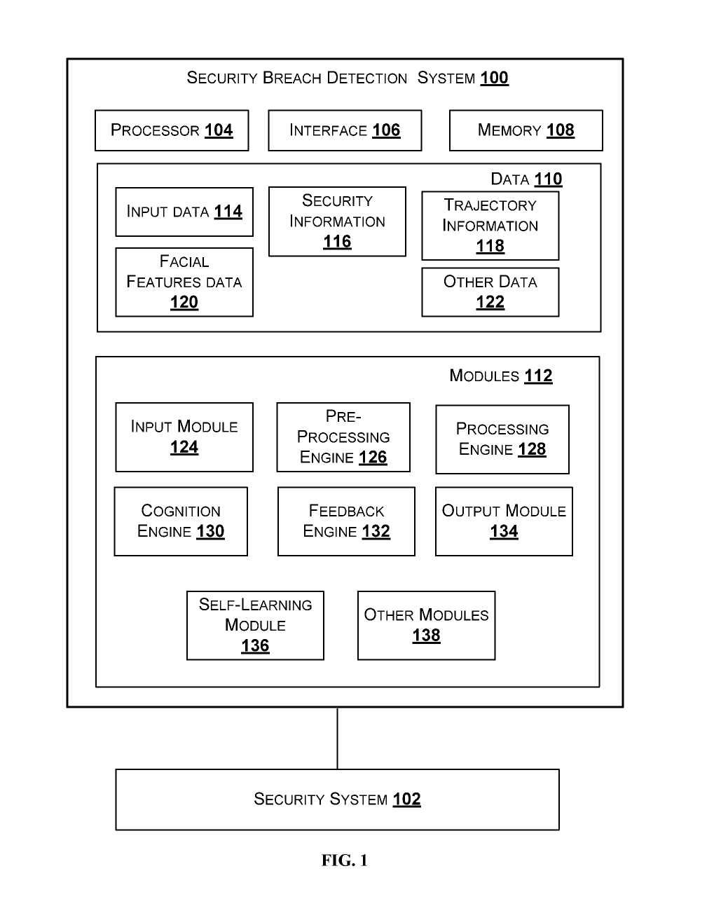

FIG. 1 illustrates a block diagram of an exemplary security breach detection system 100 for detecting a security breach in an organization in accordance with some embodiments of the present disclosure. The security breach detection system 100 is communicatively connected to security system 102. Examples of the security system 102 may include, but not limited to, security video surveillance system which records data captured by camera, biometric swipe capture machines, Radio Frequency Identification (RFID) machine database, input from retina scanner, database of the employees of the organization with which this data is compared. It may be understood by a person skilled in the art that any other third party surveillance system can be used with method of the present disclosure.

The security breach detection system 100 may include at least one central processing unit (“CPU” or “processor”) 104 and a memory 108 storing instructions executable by the at least one processor 104. The processor 104 may comprise at least one data processor for executing program components for executing user- or system-generated requests. A user may include a person, a person using a device such as those included in this disclosure, or such a device itself. The memory 108 is communicatively coupled to the processor 104. In an embodiment, the memory 108 stores security related information for detecting breach of security in an organization. The security breach detection system 100 further comprises an I/O interface 106. The I/O interface 106 is coupled with the processor 104 through which the input is received.

In an embodiment, one or more data 110 may be stored within the memory 108. The one or more data 110 may include, for example, input data 114, security information 116, trajectory information 118, facial features data 120, and other data 122.

In an embodiment, the input data 114 comprises input from the security system 102. The input data may be data from at least one or more security systems like RFID readers, biometrics authentication like fingerprint scanner and retina scanners, turnstiles, security video camera feeds and employee database.

The security information 116 is generated using the input data 114. In an embodiment, the security information is generated by converting the input data 114 into a predefined system friendly format which can be easily processed by the system. For example, all the video feeds are coming in stream and processing is performed in real-time, so the live video feeds are converted into frames and sent for further processing. Further, the security information may also include humans detected in the video feed frames with the coordinates of human in the respective frames.

The trajectory information 118 comprises a unique trajectory of movement for each person in the organization. The trajectory information 118 helps in identifying each person inside the organization and tracks their movement inside the organization.

The facial features data 120 comprises facial features extracted from a human face. Since the face image is captured by the camera from various angles, three-dimensional recognition is performed where not only the face characteristics but depth, nose, chin surface, skin color and contour of the eye sockets are also identified to generate the facial features data 120.

In an embodiment, the data 110 in the memory 108 is processed by the modules 112 of the processor 104. The modules 112 may be stored within the memory 108. In one implementation, the modules may include, for example, an input module 124, a preprocessing engine 126, a processing engine 128, a cognition engine 130, a feedback engine 132, an output module 134 and a self-learning module 136. The security breach detection system 100 may also comprise other modules 138 to perform various miscellaneous functionalities of the system 100. It will be appreciated that such aforementioned modules may be represented as a single module or a combination of different modules.

In an embodiment, the input module 124 receives input data 114 from the security system 102. The input module 124 notifies the preprocessing module 126 about all the available input sources and authentication databases for correlation. All the security systems 102 that are to be used for enhancing security is plugged into the input module 124 for establishing a bridge between the security breach detection system 100 and the organization premises. The security system 102 which may be connected to the input module 124 are RFID readers, biometrics authentication like fingerprint and retina scanners, turnstiles, security video camera feeds, in-premises organization authentication database. It may be understood that at least one or a combination of multiple systems can be used with the present disclosure.

The preprocessing engine 126 receives input data 114 from the input module 124 and converts the input data 114 to a predefined format for further processing by the processing engine 128. The input data 114 is designed according to the convention of organization and might have different format and structure. Therefore, a unified standard source may be needed for the security breach detection system 100 to work properly. The preprocessing engine 126 converts the input data into a system friendly format which can be easily processed by the security breach detection system 100. For example, all the video feeds are coming in stream and processing is performed in real-time, so the preprocessing engine 126 converts the live video feeds into frames and sends to the processing engine 128. Also the preprocessing engine 126 detects the humans in the video feed frames with the coordinates of human in the respective frames. In an exemplary embodiment, this is performed using known methods for human detection. The methods may include, but are not limited to, Hog, Haar classifier for human detection, blob detection or training a Support Vector Machine (SVM) classifier.

The preprocessing engine 126 also builds an architecture which can adapt dynamically based on the available input data 114. A pre-defined set of rules are used to intelligently decide the architecture of the system 100 and processing required for executing the specified architecture. For example, consider a situation where RFID readers and camera feeds are present in conjunction with employee database, then the input module 124 notifies an architecture design module (not shown) about the available input data. Then, based on rules defined, the preprocessing engine 126 can decide to process video feeds and match each individual present and passing by the RFID readers. Additional rules can be added later also to make the system 100 more robust to handle a new input data 114. Rules are majorly conditional statements which can decide the architecture. For example, a rule can be like if only RFID reader and video feeds are present, then immediately process videos feeds into frames using preprocessing engine 126 and authenticate the frames with the RFID data.

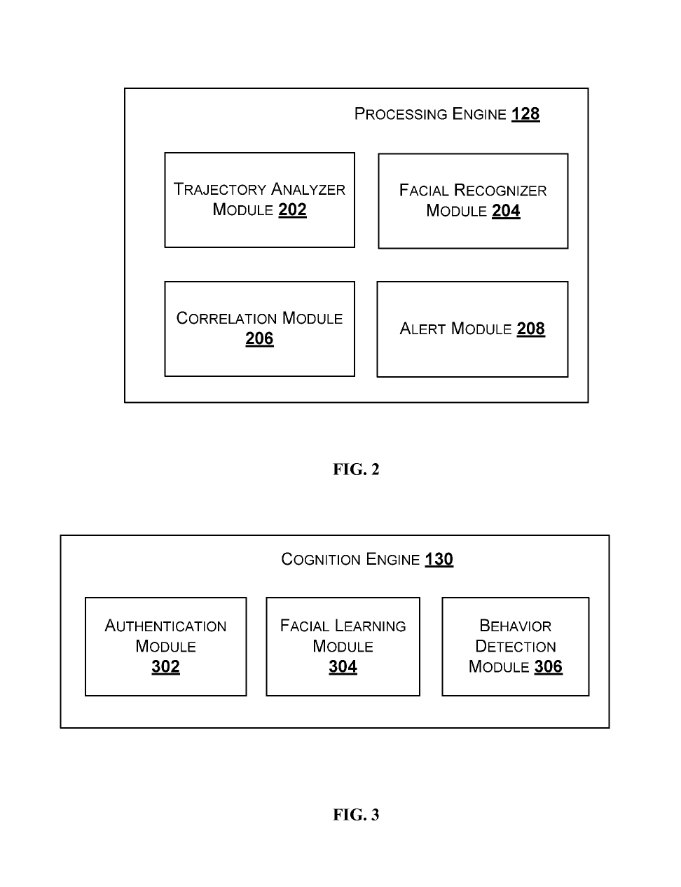

The processing engine 128 performs execution of real-time security surveillance. If there is a video in the input data 114, then the video is received by the processing engine 128 through the preprocessing module 126. From the video feed frames, the humans detected and their respective coordinates generated by the preprocessing engine 126 are used in the sub modules of processing engine 128. The sub modules of the processing engine 128 are illustrated in FIG. 2. The sub modules of the processing engine 128 comprise a trajectory analyzer module 202, a facial recognizer module 204, a correlation module 206 and an alert module 208.

The trajectory analyzer module 202 creates a unique trajectory of movement for each person by analyzing video feeds of each person inside organization. In an embodiment, the video feeds are converted into frames and then provided to the trajectory analyzer module 202 for further processing.

As an example, there are few non-limiting considerations taken into account while performing trajectory analysis of each person. The considerations may include, but are not limited to, calculating unique trajectory identification based on distance threshold of two coordinates, if the trajectory has occurred after a defined frame difference threshold, then a new trajectory is identified despite of the distance being less than the threshold, identifying same trajectory for different people in same frame is avoided if two people are together, ignoring false trajectory identification which has occurred for very less number of frames where some unidentified object has been identified as human trajectory.

The facial recognizer module 204 system identifies a person using facial recognition methods on the video input data. The facial recognizer module 204 extracts as much features as possible from a human face for performing facial recognition. Since the face image is captured by the camera from various angles, three-dimensional recognition is performed where not only the face characteristics but depth, nose, chin surface, skin color and contour of the eye sockets are also generated by the facial recognizer module 204 to identify face more accurately.

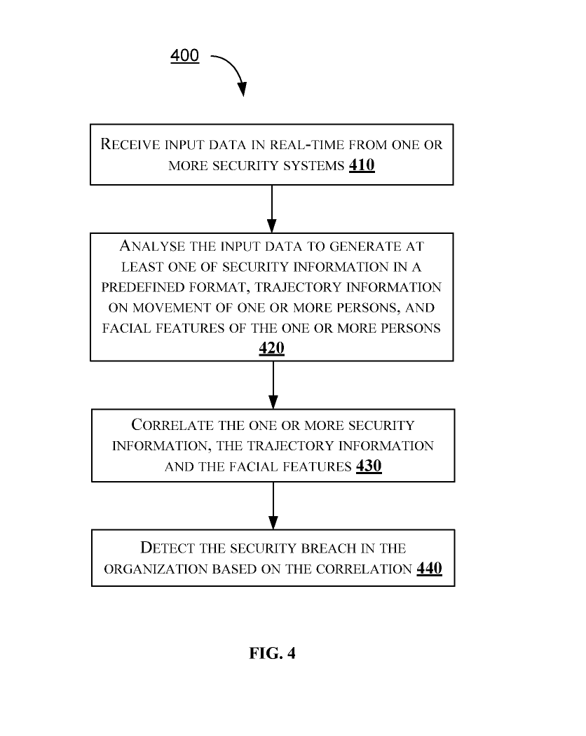

The correlation module 206 correlates the security information, trajectory information and facial features information to determine any breach of security. In an exemplary embodiment, the correlation may include checking each personnel RFID swipes data and match face of the person in real-time with the face in the employee database. The inputted face is given to the authentication module (explained in FIG. 3) which has a link to the employee database. Based on the results of the authentication module, the output is provided to the alert module 208.

Another example of correlation may include counting the number of humans identified and comparing the count with the total number of swipes at the security system 102.

In an embodiment, video feeds from various cameras installed inside the secured premises of an organization are analyzed. With the help of the facial recognition module 204, the correlation module 206 identifies the face and correlates with the employee database for validated entry.

As another exemplary embodiment, once a person is inside a secured premises and trying to access a terminal/machine to login inside the network, a correlation is performed by the correlation module 206 which checks whether the logged in person is already authenticated at the main entrance to make sure only authenticated persons are only allowed to access secured terminals.

The alert module 208 analyzes the alerts and security breaches. In an embodiment, the alert module divides the alerts and breaches into priority levels based on the location and type of incidents happening. The alert module 208 then categorizes all the breaches based on their priority levels. Further, the alert module 208 decides that which alert or breach is to be sent to the output module 134 for notification to administrator. Also, the alert module 208 determines if pre-defined actions like revoking the access of a user etc. is to be performed.

Referring back to FIG. 1, the cognition module 130 is responsible for detecting breach of security using the information processed by the processing module 128. The cognition module comprises one or more sub modules as described in FIG. 3. The sub modules of the cognition module 130 comprise an authentication module 302, a facial learning module 304 and a behavior detection module 306.

The authentication module 302 receives the input data from the security system 102 and correlates all the information with the employee database. In case of any mismatch between the data of one security system 102 with the other, an alarm is triggered to the concerned authority, along with the details of the employee. For example, if the facial image extracted from the Closed-Circuit Television (CCTV) camera matches with an employee in the employee database and the swipe information matches with a different employee, it implies a security breach, and the details of the employees are sent to the concerned authority. Also, the authentication module 302 may validate the same data with network log of the employee, to check if the employee logged to any other machine or authentication device apart from initial log of the day.

The facial learning module 304 matches face of a person with the images available in the employee database and outputs the employee data back to the facial recognizer module 204. If the photo does not match with any of the photos in the employee database, the facial learning module 304 returns few closest match of the face and displays the same for human judgment.

The behavior detection module 306 compares the trajectory information 118 of the persons with a predefined behavior. If there is any mismatch between the trajectory information 118 of the one or more persons and the predefined behavior, then a security breach is detected. In an embodiment, the behavior detection module 306 analyzes the trajectory path of each person with the help of the learning model built for tracking abnormal behavior. The movement patterns are trained using learning models and whenever an abnormal pattern is found, the behavior detection module 306 triggers an alarm suggesting a security breach. The output of behavior detection module 306 is provided to the concerned authority for human judgment. The patterns recognized as abnormal which are detected in real scenario are prearranged with scores so as to alert similar pattern with higher confidence and fast processing.

Referring back to FIG. 1, the feedback engine 132 collects feedbacks from respective authorities regarding the abnormal behavior tracking, security breach alerts as well on the overall view of a person. This feedback is used to remove similar patterns from the training set of abnormal behavior detection. For example, if triggered security breach is genuine with permission to access the restricted area, then suggestions are provided to the authorities to input the same permissions in the input module 124.

The output module 134 provides overall information on the person. For example, the in time of the person, time spent in the restricted area to time spent in other areas apart from the restricted area with the video feed, swipe logs, network logs, time spent on using the official systems. Further, places visited on particular day, time spent at various locations, information on time spent in access restricted areas, different assets accessed from restricted areas can be visualized with percentages of time spent in each area. Complete information on person with proof of the specific cases of security breach videos or swipe information is provided by the output module 134 for visualization. This allows authorities like manager, security authorities to get the overall information of all persons without manual intervention.

When patterns of abnormal behavior are detected by the behavior detection module 306, the output module 134 provides real time triggered alert with the video or log information of the person to the authorities for taking action.

When the person enters restricted area, a first level of security alert is triggered and provided to the security personnel by the output module 134. When the same person accesses an asset such as system, printer, phone etc. in the restricted area, a second level of alert is triggered with the information on accessed asset by the output module 134.

The self-learning module 136 helps in learning of the system and improving performance of breach detection. The patterns recognized as abnormal which are detected in real scenario are prearranged with scores so as to alert similar pattern with higher confidence and fast processing. Even if false security breach alert happens, the self-learning module 136 automatically considers similar cases for further processing of different modules to check for accuracy. Only if the accuracy rate is above certain threshold, then such similar cases are notified as security breach.

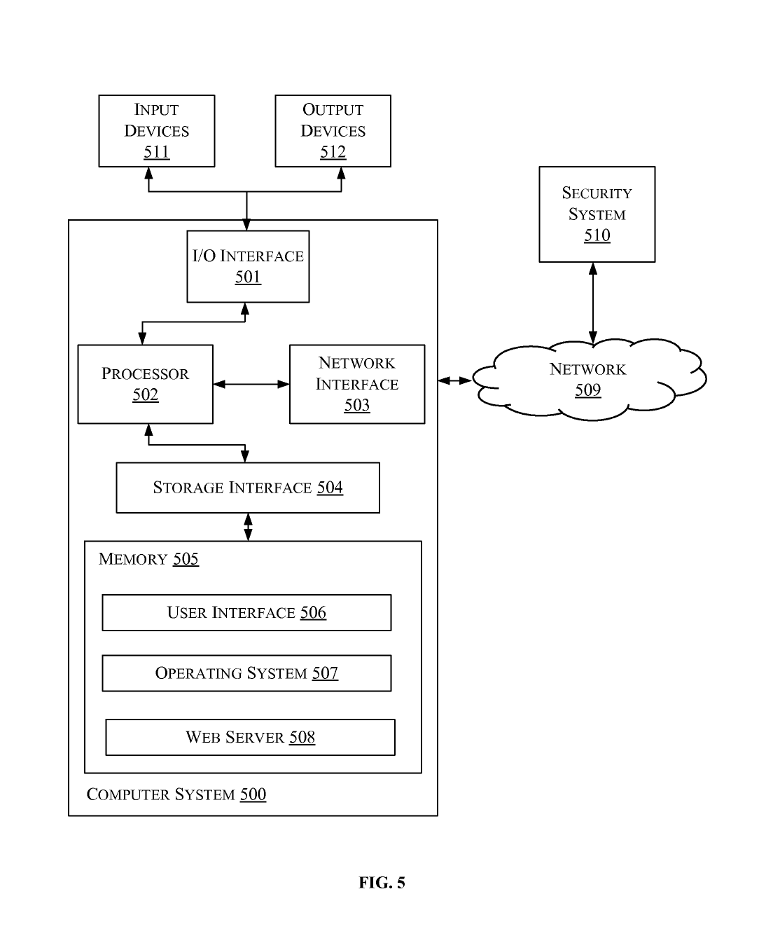

FIG. 4 shows a flowchart illustrating a method for detecting a security breach in an organization in accordance with some embodiments of the present disclosure.

As illustrated in FIG. 4, the method 400 comprises one or more blocks for detecting a security breach in an organization by the security breach detection system 100. The method 400 may be described in the general context of computer executable instructions. Generally, computer executable instructions can include routines, programs, objects, components, data structures, procedures, modules, and functions, which perform particular functions or implement particular abstract data types.

The order in which the method 400 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 410, receive the input data 114 in real-time from the security system 102. In an embodiment, the input module 124 receives the input data 114 from the security system 102. The input module 124 identifies the received data based on the authentication data sources like RFID readers, fingerprint reader, CCTV cameras etc.

At block 420, analyze the input data 114 to generate at least one of the security information 116 in a predefined format, the trajectory information 118 on movement of one or more persons and the facial features 120 of the one or more persons. In an embodiment, the different types of input data 114 are converted into user friendly format. Further, the input data 114 is used to plot trajectories of human movement based on the human detected co-ordinates in the consequent frames. Also, facial featured of person are extracted from the images of the user extracted from the live feed.

At block 430, correlate the security information, the trajectory information and the facial features. In an embodiment, the security information can be correlated with each other, for example, the swipe data can be correlated with the information of the person in the employee database. In an embodiment, the step of correlation matches the trajectory information of the personnel with the RFID swipe information, and records the breach if a person enters an access restricted arena without logging in. Since the trajectory describes the path of the personnel, it can be accurately used to determine whether the person is going inside the door or merely moving near the door. In an embodiment, face of the person recognized from the video input data is correlated with the employee database for validated entry.

At block 440, detect the security breach in the organization based on the correlation. The output from the correlation module 206 is used to determine breach of security by a person. The output module 134 then takes input from the correlation module 206 and triggers notifications at real-time to the authorities for any incident that are classified as security breach or abnormal activity by the correlation module 206.

When a security breach or abnormal behavior is triggered and reported, the information is provided to the self-learning module 136 for learning. For the triggered alerts, feedback is collected from the authorities through the feedback engine 132 and the self-learning module 136 removes the patterns which are triggered as abnormal but found out to be genuine. The feedback engine 132 provides a user interface which has the records of those instances that are marked as suspicious, and sent from the output module 134. Each record contains video footage and the information from the corresponding security system 102. The concerned authority has the option to flag the suspicious records as either genuine or breach. The feedback engine 132 inputs the same to train the self-learning module 136, the facial learning module 304 and the behavior detection module 306. Over time, the accuracy of the security breach detection is improved with more training set.

### Computer System

FIG. 5 illustrates a block diagram of an exemplary computer system 500 for implementing embodiments consistent with the present disclosure. In an embodiment, the computer system 500 is used to implement the security breach detection 100. The computer system 500 determines breach of security in an organization. The computer system 500 may comprise a central processing unit (“CPU” or “processor”) 502. The processor 502 may comprise at least one data processor for executing program components for executing user- or system-generated business processes. A user may include a person, a person using a device such as such as those included in this disclosure, or such a device itself. The processor 502 may include specialized processing units such as integrated system (bus) controllers, memory management control units, floating point units, graphics processing units, digital signal processing units, etc.

The processor 502 may be disposed in communication with one or more input/output (I/O) devices (511 and 512) via I/O interface 501. The I/O interface 501 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 501, the computer system 500 may communicate with one or more I/O devices (511 and 512). For example, the input device 711 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device 512 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the processor 502 may be disposed in communication with a communication network 509 via a network interface 503. The network interface 503 may communicate with the communication network 509. The network interface 503 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 509 may include, without limitation, a direct interconnection, local area network (LAN), wide area network (WAN), wireless network (e.g., using Wireless Application Protocol), the Internet, etc. Using the network interface 503 and the communication network 509, the computer system 500 may communicate with security system 510.

In some embodiments, the processor 502 may be disposed in communication with a memory 505 (e.g., RAM, ROM, etc. not shown in FIG. 5) via a storage interface 504. The storage interface 504 may connect to memory 505 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program or database components, including, without limitation, user interface application 506, an operating system 507, web server 508 etc. In some embodiments, computer system 500 may store user/application data 506, such as the data, variables, records, etc. as described in this disclosure. Such databases may be implemented as fault-tolerant, relational, scalable, secure databases such as Oracle or Sybase.

The operating system 507 may facilitate resource management and operation of the computer system 500. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 517 may facilitate display, execution, interaction, manipulation, or operation of program components through textual or graphical facilities. For example, user interfaces may provide computer interaction interface elements on a display system operatively connected to the computer system 500, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 500 may implement a web browser 508 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 500 may implement a mail server 519 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 500 may implement a mail client stored program component. The mail client may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, nonvolatile memory, hard drives, CD ROMs, DVDs, flash drives, disks, and any other known physical storage media.

Advantages of the embodiment of the present disclosure are illustrated herein.

In an embodiment, the present disclosure utilizes multiple sources of information and detects security breach accurately in real-time.

In an embodiment, the present disclosure provides integration of all the available information of employees and triggering of real time notification of the security breach. This allows organizations to take necessary actions on the employees involving in activities against company policies.

In an embodiment, the present disclosure an adaptive model which evolves over time and behaves according to the organization in which it is deployed to take intelligent decision in detecting security breach.

In an embodiment, the present disclosure provides system which can detect abnormal behavior of an employee and notify for any security breach or threat.

In an embodiment, the present disclosure provides a system which has real-time data of authorized personnel access. The system can intelligently notify if an unknown unauthenticated person is detected in restricted premises.

In an embodiment, the present disclosure provides added security with the existing security infrastructure without addition of extra time or change during authentication and also uses existing databases to perform its task.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media comprise all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the invention, and that the article of manufacture may comprise suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of this technology.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of this technology need not include the device itself.

The illustrated operations of FIG. 4 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of this technology is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for detecting organizational security breaches, the method comprising:
receiving, by a security breach detection computing device, input data in real-time from one or more security systems;
analyzing, by the security breach detection computing device, the input data to generate at least one of security data in a predefined format, trajectory data identifying movement of one or more persons, or facial feature data identifying one or more facial features of the one or more persons;
correlating, by the security breach detection computing device, the security data, the trajectory data, or the facial features data; and
detecting, by the security breach detection computing device, a security breach in an organization based on the correlation.

2. The method as claimed in claim 1, wherein the correlating further comprises:
comparing the trajectory data of the one or more persons with predefined behavior data, wherein the predefined behavior data is updated based on one or more captured past experiences of the one or more persons and is personalized based on a type of work of each of the one or more persons; and
determining a mismatch between the trajectory data of the one or more persons and the predefined behavior data.

3. The method as claimed in claim 1, wherein the security data comprises at least one of authentication details, swipe data, login data, a count of the one or more persons, or one or more frames of at least one video feed.

4. The method as claimed in claim 1, wherein the one or more security systems comprise one or more Radio-Frequency Identification (RFID) readers, biometric scanners, image capturing units, or authentication databases.

5. The method as claimed in claim 1, wherein the analyzing further comprises:
segmenting the input data based on a format of the input data; and
determining one or more rules to process the segmented input data to generate the security data.

6. The method as claimed in claim 1, further comprising generating, by the security breach detection computing device, one or more alerts in real-time upon detecting the security breach, wherein the alerts comprise data identifying the one or more persons including at least one of an entry time, an exit time, an employee identification number, one or more swipe logs, one or more network logs, or a time spent in one or more different locations.

7. A security breach detection computing device, comprising a processor and a memory coupled to the processor which is configured to be capable of executing programmed instructions comprising and stored in the memory to:
receive input data in real-time from one or more security systems;
analyze the input data to generate at least one of security data in a predefined format, trajectory data identifying movement of one or more persons, or facial feature data identifying one or more facial features of the one or more persons;
correlate the security data, the trajectory data, or the facial features data; and
detect a security breach in an organization based on the correlation.

8. The security breach detection computing device as claimed in claim 7, wherein the processor is further configured to be capable of executing at least one additional programmed instruction comprising and stored in the memory to:
compare the trajectory data of the one or more persons with predefined behavior data, wherein the predefined behavior data is updated based on one or more captured past experiences of the one or more persons and is personalized based on a type of work of each of the one or more persons; and
determine a mismatch between the trajectory data of the one or more persons and the predefined behavior data.

9. The security breach detection computing device as claimed in claim 7, wherein the security data comprises at least one of authentication details, swipe data, login data, a count of the one or more persons, or one or more frames of at least one video feed.

10. The security breach detection computing device as claimed in claim 7, wherein the one or more security systems comprise one or more Radio-Frequency Identification (RFID) readers, biometric scanners, image capturing units, or authentication databases.

11. The security breach detection computing device as claimed in claim 7, wherein the processor is further configured to be capable of executing at least one additional programmed instruction comprising and stored in the memory to:
segment the input data based on a format of the input data; and
determine one or more rules to process the segmented input data to generate the security data.

12. The security breach detection computing device as claimed in claim 7, wherein the processor is further configured to be capable of executing at least one additional programmed instruction comprising and stored in the memory to generate one or more alerts in real-time upon detecting the security breach, wherein the alerts comprise data identifying the one or more persons including at least one of an entry time, an exit time, an employee identification number, one or more swipe logs, one or more network logs, or a time spent in one or more different locations.

13. A non-transitory computer readable medium having stored thereon instructions for detecting organizational security breaches comprising executable code which when executed by at least one processor, causes the processor to perform steps comprising:
receiving input data in real-time from one or more security systems;
analyzing the input data to generate at least one of security data in a predefined format, trajectory data identifying movement of one or more persons, or facial feature data identifying one or more facial features of the one or more persons;
correlating the security data, the trajectory data, or the facial features data; and
detecting a security breach in an organization based on the correlation.

14. The non-transitory computer readable medium as claimed in claim 13, wherein the correlating further comprises:
comparing the trajectory data of the one or more persons with predefined behavior data, wherein the predefined behavior data is updated based on one or more captured past experiences of the one or more persons and is personalized based on a type of work of each of the one or more persons; and
determining a mismatch between the trajectory data of the one or more persons and the predefined behavior data.

15. The non-transitory computer readable medium as claimed in claim 13, wherein the security data comprises at least one of authentication details, swipe data, login data, a count of the one or more persons, or one or more frames of at least one video feed.

16. The non-transitory computer readable medium as claimed in claim 13, wherein the one or more security systems comprise one or more Radio-Frequency Identification (RFID) readers, biometric scanners, image capturing units, or authentication databases.

17. The non-transitory computer readable medium as claimed in claim 13, wherein the analyzing further comprises:
segmenting the input data based on a format of the input data; and
determining one or more rules to process the segmented input data to generate the security data.

18. The non-transitory computer readable medium as claimed in claim 13, further having stored thereon instructions comprising executable code which when executed by the processor further causes the processor to perform at least one additional step comprising generating one or more alerts in real-time upon detecting the security breach, wherein the alerts comprise data identifying the one or more persons including at least one of an entry time, an exit time, an employee identification number, one or more swipe logs, one or more network logs, or a time spent in one or more different locations.
